(19) United States
(12) Patent Application Publication
(10) Pub. No.: US 2013/0327728 A1
(43) Pub. Date: Dec. 12, 2013

(54) Process for Collecting Sediment from a Settling Tank

(71) Applicants: Shanshan Jin, Great Falls, VA (US); Stephen A. Antolich, Pittsburgh, PA (US); Lisa A. Peterson, Mohnton, PA (US); Stephen J. Fenwick, Berwyn, PA (US); Ludovica Ursoi, Reading, PA (US); Jason C. Ruch, Elverson, PA (US)

(72) Inventors: Shanshan Jin, Great Falls, VA (US); Stephen A. Antolich, Pittsburgh, PA (US); Lisa A. Peterson, Mohnton, PA (US); Stephen J. Fenwick, Berwyn, PA (US); Ludovica Ursoi, Reading, PA (US); Jason C. Ruch, Elverson, PA (US)

(73) Assignee: Brentwood Industries, Inc.

(21) Appl. No.: 13/492,819

(22) Filed: Jun. 9, 2012

(51) Int. Cl. B01D 21/24; B01D 21/02

(52) U.S. Cl. 210/803; 210/523

(57) ABSTRACT

A method of removing sediment from the bottom of a settling collects the sediment from the compressed Zone IV layer of sediment adjacent the floor of the settling tank. The process utilizes a fabricated metal sludge collection system having a central truck and a pair of triangularly shaped header wings extending laterally to each side of the central truck. The header wings have an open throat that allows the passage of the Zone IV sediment layer into the header wing, while the diagonally oriented, rearwardly extending side edges of the header wing have elastomeric sweeps attached to prevent the sediment from passing out of the header wing. The sweeps accumulate the sediment at the rearwardly trailing apex of the header wing where a pump extracts the accumulated sediment remotely from the settling tank. A T-connector is formed with a baffle to improve the discharge of sediment from the header wings.

### FIELD OF THE INVENTION

This invention relates generally to a water clarification system, and more particularly, to a method of collecting sediment from the bottom of a settling tank and discharging the collected sediment remotely from the settling tank.

### BACKGROUND OF THE INVENTION

Rectangular settling tanks are commonly used to remove solids from water collected within water treatment plants before further treatment of the water for consumption. The solids settle to the bottom of the sedimentation basin, which can be a rectangular concrete settling tank, in identifiable layers with the lowermost layer next to the floor of the sedimentation basin being the most dense and compact. Periodically, the collected sludge needs to be removed from the sedimentation basin to maintain the effectiveness and efficiency of the sedimentation basin.

Removal of the collected sludge is conventionally accomplished by a submerged sludge collector that essentially vacuums the sludge from near the bottom of the settling tank. One such sludge collection system is sold by F. B. Leopold Company under the trademark of Clari-Trac-2™, wherein a transverse header extends on opposing sides of a central cable-driven truck that travels along a linear guide rail to move the transverse header longitudinally along the bottom of the settling tank. Other similar submerged sludge collector systems are sold by MRI, Eimco and Monroe. The transverse header is a conduit that is formed with openings through which the sludge is drawn by a vacuum applied to the transverse header by a flexible hose through which the vacuum is applied by a remote pump. The sludge is collected into the transverse header and then removed from the settling tank through the remote pump.

A similar sludge removal apparatus is also commercially available through Siemens Water Technologies Corporation under the trademark of Sludge Sucker™ Ovivo also sells commercially a sludge collection system under the trademark of EWT™ Trac-Vac™ Sludge Collector, which also draws sludge from the bottom of the settling tank through a transverse header conduit attached to a central truck that is driven by a pneumatic drive mechanism requiring a flow of compressed air to the central truck.

Meurer Research, Inc and Monroe Environmental Corporation market a hoseless sludge collector system that incorporates a rigid telescoping conduit to accommodate the movement of the transverse header conduits along the floor of the rectangular settling tanks. As with the other sludge removal systems identified above, the sludge is removed through openings in the transverse header conduit by virtue of a vacuum applied to the transverse header conduit by a pump that is located remotely. The transverse header in each hoseless sludge collection system is mounted on a central truck that is moved along the floor of the settling tank by a cable drive mechanism.

Brentwood Industries, Inc., through its Polychem Systems Division, has marketed a sludge collection system formed as a pair of triangularly shaped header wings that were suspended from a drive chassis positioned between the header wings to create a negative pressure area beneath the header wings for the purpose of drawing sediment into an extraction apparatus mounted on top of the wing. The header wings were provided with a narrow throat opening that would draw sediment and water through the throat opening due to the negative pressure induced beneath the header wing. This sludge collection system, marketed as the Polychem/WEDA Self-Driven Sediment Pumping System did not completely extract sediment from the lowermost compacted sludge layer next to the floor of the tank. The Polychem/WEDA sludge collection system utilized an electrically driven traction device manufactured by Weda Water, Inc.

Each of the above sludge collection and removal systems suffers from a similar problem of not entirely removing the lowermost sludge layer adjacent to the floor of the settling tank. Sedimentation in a settling tank falls into four zones. The uppermost zone (Zone I) is referred to as the discrete particle settling zone where sedimentation particles settle without interaction with neighboring particles. The next sedimentation zone (Zone II) is referred to as the flocculent particle zone in which flocculation increases the mass of the sedimentation. The Zone III sedimentation zone is the hindered settling zone where the mass of particles tend to settle as a unit with individual particles remaining in a fixed position relative to one another. The lowermost sedimentation zone (Zone IV) is the compressed or compaction zone where the concentration of particles is so dense that the zone is compacted, which is typically the sludge zone within a settling tank. Each of the above-described systems is configured to sludge that is above the lowermost compressed zone adjacent the floor of the settling tank. Thus, the efficiency of each of these sludge collection and removal systems is less than optimal.

Nevertheless, these sludge collection systems are an improvement over the earlier sludge collection configurations, such as is depicted in U.S. Pat. No. 6,099,743, granted to John E. Pedersen on Aug. 8, 2000, in which the floor of the settling basin is sloped to drain sludge by gravity and by current flows into a sludge pit at the end of the settling tank where a pump extracts the collected sludge from the pit. In a circular settling tank, the sludge can be swept by a rotating vane into a central pit from which the sludge is pumped to a remote location, as is disclosed in U.S. Pat. No. 6,536,606, issued on Mar. 25, 2003, to Jeffrey J. Schneider.

It would be desirable to provide a more effective and efficient sludge collection and removal system for use in sedimentation basins, particularly in rectangular settling tanks. It would further be desirable to provide a cable-driven sludge collector formed with header wings to consolidate the collected sludge into an apex where the collected sludge can be removed by a pump or by a vacuum for disposal remotely from the settling tank. It would also be desirable to provide an improved cable drive mechanism for powering the movement of the sludge collection system along the floor of a settling tank.

### SUMMARY OF THE INVENTION

It is an object of this invention to provide an improved sludge collection and removal system that overcomes the disadvantages of the prior art.

It is another object of this invention to provide a sludge collector for submersed operation along the bottom of a settling tank that will collect and remove accumulated sludge with a greater efficiency than is known in the prior art.

It is an advantage of this invention that sludge from the lowermost compressed zone is removed from the settling tank.

It is a feature of this invention that the throat of the header wings is fully opened to enhance the collection of sludge from the compressed zone.

It is another feature of this invention that the header wings are triangularly shaped with the hypotenuse thereof corresponding to the open throat of the header wing with the header wing supported on wheels and by a pivot pin connection to the drive chassis.

It is another advantage of this invention that the collected sludge is consolidated at the rearward apex of the header wing to be pumped from the header wing.

It is still another feature of this invention that a cable drive mechanism provides the power for movement of the sludge collection system over the floor of the settling tank.

It is another object of this invention to provide a cable drive mechanism for moving the sludge collection system over the floor of a settling tank to collect and discharge sedimentation therefrom.

It is yet another feature of this invention that the drive chassis is formed with spring-loaded connectors for attachment to cables that are driven by a remote winch to move the sludge collection system across the floor of the settling tank.

It is still another advantage of this invention that an impact of the sludge collection system while moving along the bottom of the settling tank can be absorbed within the spring-loaded drive chassis to prevent the cable from breaking.

It is yet another feature of this invention that each header wing has a pump mounted thereon at the apex of the header wing to extract the consolidated sludge from the header wing.

It is still another object of this invention to provide a connector for the sludge collection mechanism that will connect two hoses running from the respective header wing pumps to combine the discharge into a single flexible hose for the removal of the collected sludge from the settling tank.

It is another feature of this invention that the connector is formed with a baffle separating the two inlet ports through to the discharge port.

It is yet another advantage of this invention that the baffle prevents the discharge of the pump on one header wing from overpowering the discharge from the pump on the other header wing.

It is still another feature of this invention that the baffle defines a Y-valve in the T-joint interconnecting discharge hoses from the discharge pumps mounted on the header wings.

It is still another advantage of this invention that the Y-valve prevents short-circuiting the vacuum applied to a header wing by the discharge pumps.

It is another feature of this invention that the sludge collection system is formed with fabricated metal header wings for collecting sediment from a water settling tank.

It is another advantage of this invention that the fabricated metal header wings are operable to collect sediment from the compacted Zone IV layer of sediment along the floor of the settling tank.

It is still another feature of this invention that the header wings are provided with a flexible elastomeric sweep along the rearwardly converging sides of the header wings.

It is yet another feature of this invention that the header wings are equipped with elastomeric sweeps attached to the rear diagonally extending sides of the header wings.

It is yet another advantage of this invention that the elastomeric sweeps on the header wings help direct the Zone IV compaction layer of sediment into the apex of the header wing for extraction and removal from the settling tank.

It is another feature of this invention that the sludge collection system can be coupled with settlers positioned within the settling tank to facilitate the removal of sediment from the water within the settling tank.

It is still another advantage of this invention that the sludge collection system can be operated underneath the settler blocks without impeding the operation thereof.

It is a further object of this invention that the process of collecting sediment from a settling tank collects the Zone IV compaction layer of sediment adjacent the floor of the settling tank.

It is a feature of this invention that the skirt attached to the rear diagonally extending edges of the fabricated metal header wings sweeps the sediment from the compaction Zone IV layer along the floor of the settling tank into the apex of the header wings for removal therefrom by pumps mounted on the top of the header wings.

It is another feature of this invention that the collected sludge from the compaction Zone IV layer accumulates in the apex of the header wings to fill the apex for extraction thereof from the header wing.

It is an advantage of this invention that the accumulated sludge in the apex of the header wings limits the less dense sediment zones from the extraction process.

It is another advantage of this invention that the accumulation of sludge within the apex of the header wings pushes the less dense sediment zones forwardly through the open throat of the header wings to be swept over top of the header wings and deposited on the floor of the settling tank rearwardly of the header wings.

It is still another object of this invention to provide a submersible sludge collection system for use along the floor of a settling tank or a sedimentation basin, which is durable in construction, inexpensive of manufacture, carefree of maintenance, facile in assemblage, and simple and effective in use.

These and other objects, features and advantages are accomplished according to the instant invention by providing a method of removing sediment from the bottom of a settling tank or sedimentation basin that collects the sediment from the compressed Zone IV layer of sediment adjacent the floor of the settling tank. The process utilizes a fabricated metal sludge collection system having a central truck and a pair of triangularly shaped header wings extending laterally to each side of the central truck. The header wings have an open throat that allows the passage of the Zone IV sediment layer into the header wing, while the diagonally oriented, rearwardly extending side edges of the header wing have elastomeric sweeps attached to prevent the sediment from passing out of the header wing. The sweeps accumulate the sediment at the rearwardly trailing apex of the header wing where a pump extracts the accumulated sediment remotely from the settling tank. A T-connector is formed with a baffle to improve the discharge of sediment from the header wings.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a partial perspective view of a rectangular settling tank having portions broken away to view the sludge collection system mounted along the floor of the settling tank and incorporating the principles of the instant invention;

FIG. 2 is a top plan view of the settling tank shown in FIG. 1;

FIG. 3 is a cross-sectional view of the settling tank taken along lines 3-3 of FIG. 2 to depict a front elevational view of the sludge collection system mounted along the floor of the settling tank;

FIG. 4 is an exploded view of the sludge collection system incorporating the principles of the instant invention;

FIG. 5 is a top plan view of the left header wing with the discharge pump being removed for purposes of clarity;

FIG. 6 is a front elevational view of the shell of the header wing;

FIG. 7 is a bottom plan view of the left header wing showing the roller supports supporting the header wing shell for movement along the floor of the settling tank;

FIG. 8 is an enlarged perspective view of the drive unit of the cable drive mechanism corresponding to circle—8 of FIG. 1;

FIG. 9 is an enlarged perspective view of the home point sheave forming part of the cable drive mechanism corresponding to circle—9 of FIG. 1;

FIG. 10 is an enlarged perspective view of the return point sheave forming a part of the cable drive mechanism corresponding to circle—10 of FIG. 1;

FIG. 11 is a perspective view of the truck chassis incorporating the principles of the instant invention;

FIG. 12 is a top plan view of the truck chassis shown in FIG. 11;

FIG. 13 is a perspective view of the T-connector interconnecting the two discharge hoses from the header wing pumps with a single discharge hose, and incorporating the principles of the instant invention;

FIG. 14 is a top plan view of the connector shown in FIG. 15; and

FIG. 15 is a schematic diagram corresponding to a cross-section through a header wing to depict the consolidation and accumulation of sediment in the apex of the header wing, arrows depicting the passing of other layers over top of the header wing.

### DETAILED DESCRIPTION OF THE PREFERRED EMBODIMENT

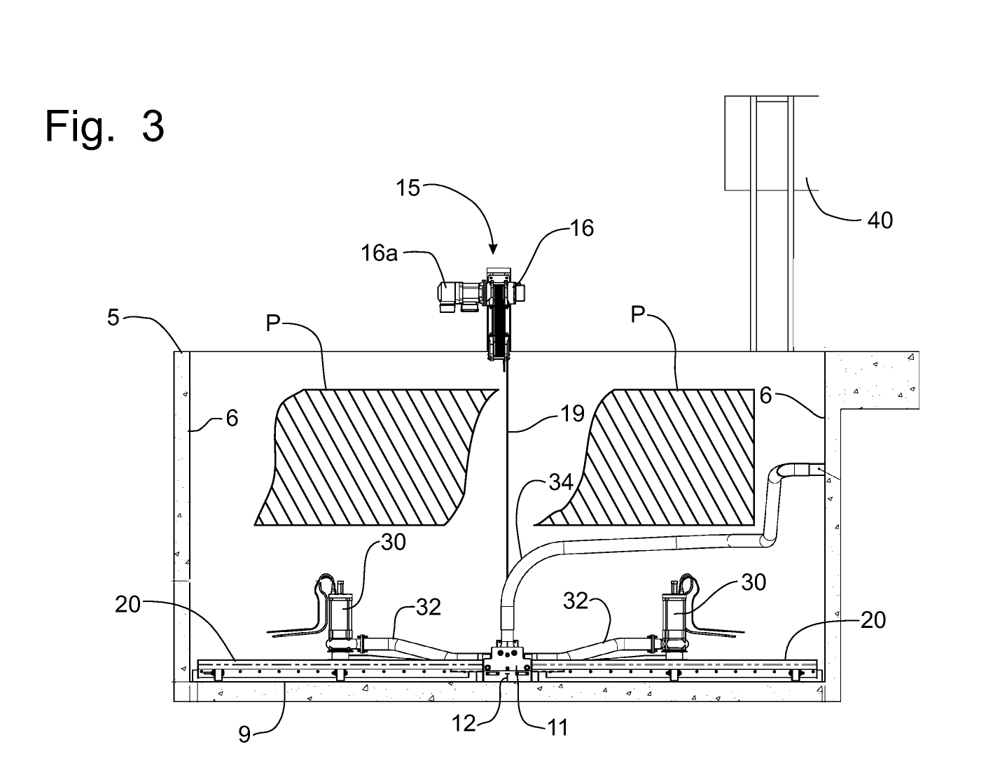

Referring to the drawings, a sludge collection system incorporating the principles of the instant invention can best be seen. The sludge collection system 10 is mounted along the floor of a settling tank 5 which is used for settling entrained solids from a supply of water supplied to the settling tank 5 through the inlet (not shown). The velocity of the water is slowed to allow the large entrained solids to settle to the bottom surface or floor 9 of the settling tank 5. In some circumstances, a precipitator or settler P, as is schematically depicted in FIG. 3, can be added to the water supply within the settling tank 5 to facilitate the precipitation of suspended solids to the bottom surface 9 of the settling tank 5.

The sludge collection system 10 is mounted for operation along the floor of a settling tank to collect and remove the sediment accumulated thereon due to the operation of the settling tank 5. Although the drawings depict the settling tank 5 as being rectangular and being of a certain size that matches with a single pair of header wings 30 spanning from one transversely spaced wall 6 to the other vertical wall 6, one skilled in the art will recognize that the settling tank 5 can be formed in other shapes, including a circular settling tank 5 or a rectangular settling tank 5 that has a span between the transversely opposed vertical side walls 6 that is sufficiently large as to require two or more sludge collection systems 10, which could be independently or simultaneously operable.

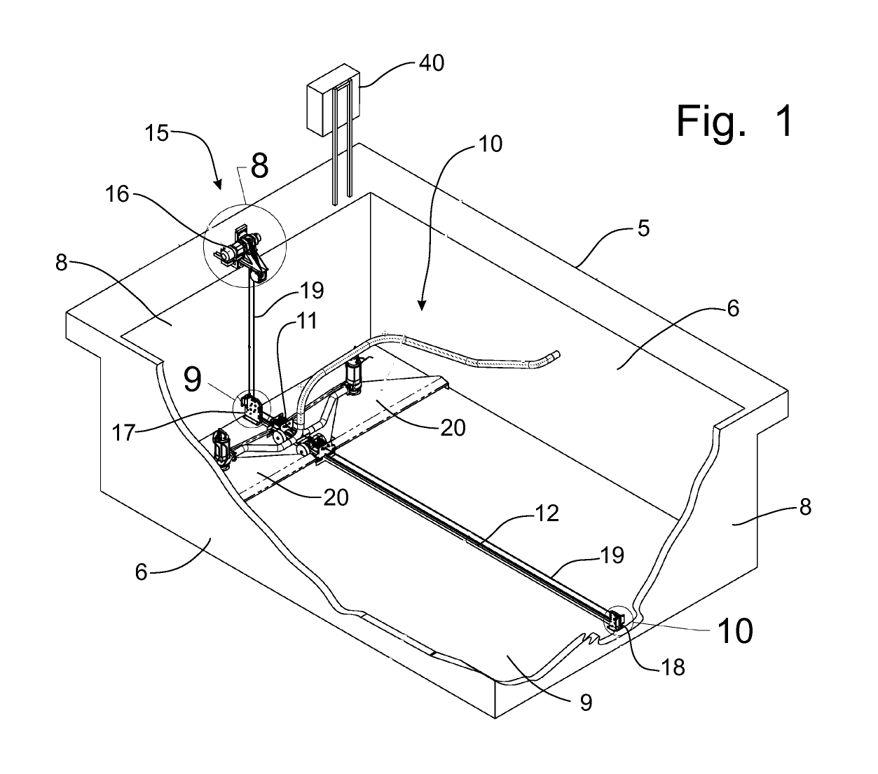

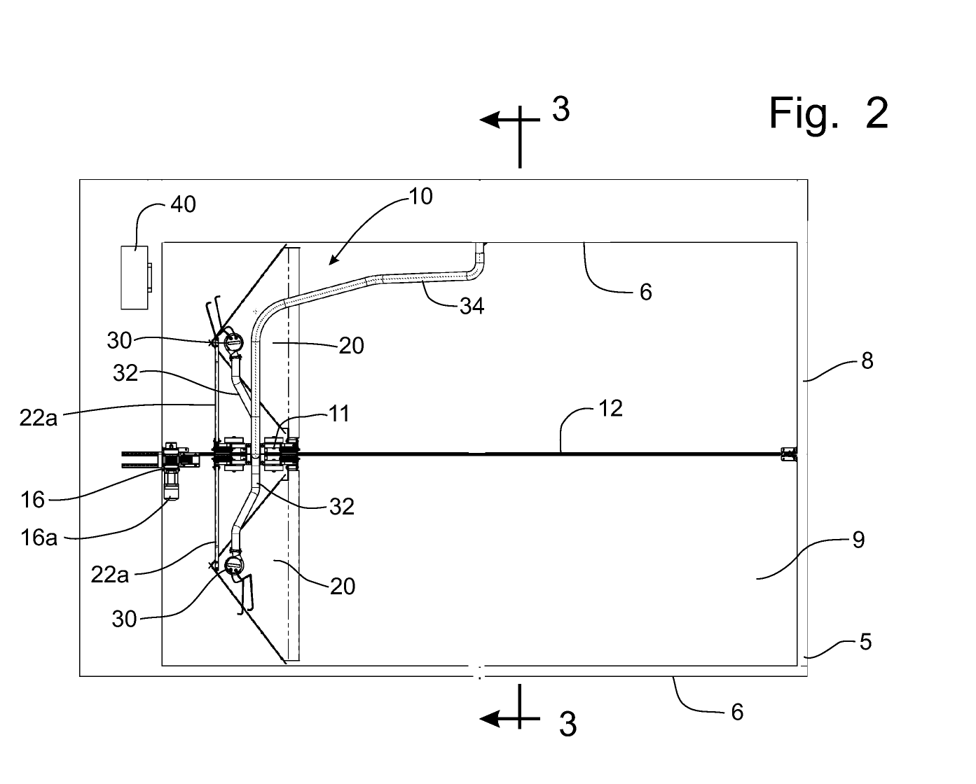

As best seen in FIGS. 1-4, 11 and 12, the sludge collection system 10 includes a central truck or chassis 11 that is engaged with a guide rail or track 12 mounted on the floor 9 of the settling tank 5. Preferably, the guide rail 12 extends between a home point sheave 17 mounted on one end wall 8 of the settling tank 5 and a return point sheave 18 mounted on the opposing end wall 8, forming part of the cable drive mechanism 15, as will be discussed in greater detail below. The truck 11 is preferably formed with rollers or wheels 13 that facilitate the movement of the truck 11 along the bottom floor 9 of the settling tank 5. The truck or chassis 11 is connected to the cable drive mechanism, described in greater detail below. The chassis 11 includes pre-tensioned springs 14b that provide a shock-absorbing capability to the connection plates 14a at the front and rear ends 14 of the chassis 11 for connection of the chassis 11 to the cable 19. In operation, the pre-tensioned springs 14b allow the header wings 20 or the chassis 11 to impact an obstacle within the settling tank 5 without causing the cable 19 or the chassis 11 to break.

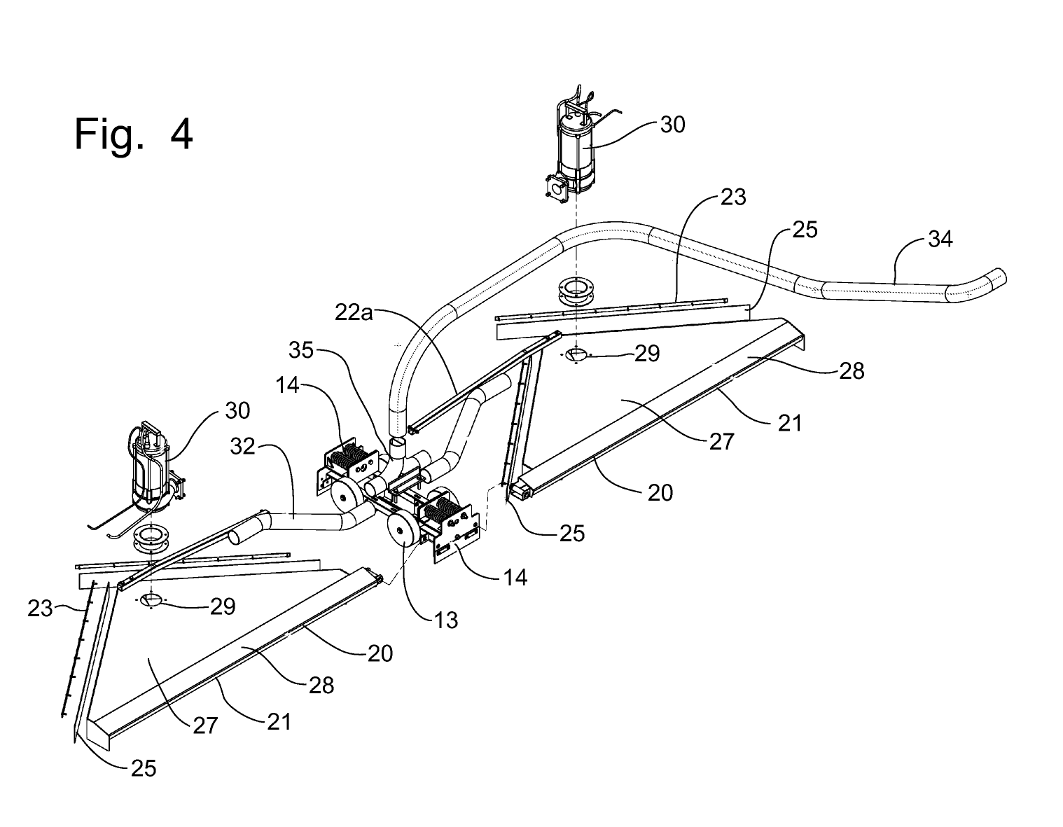

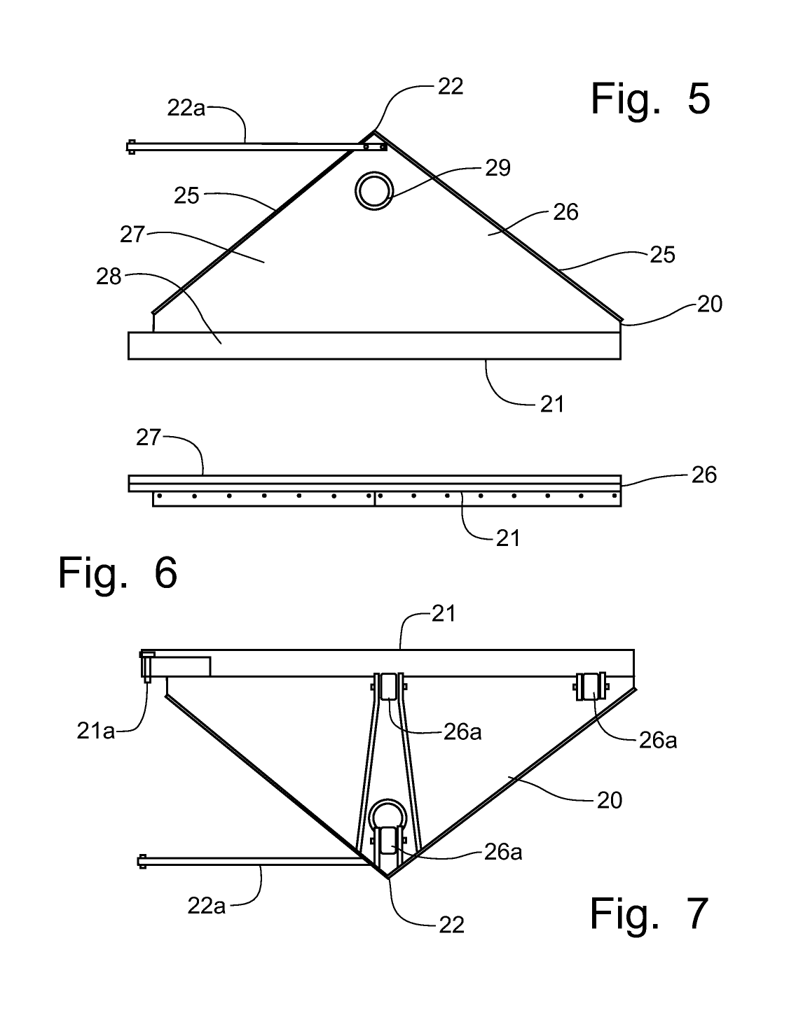

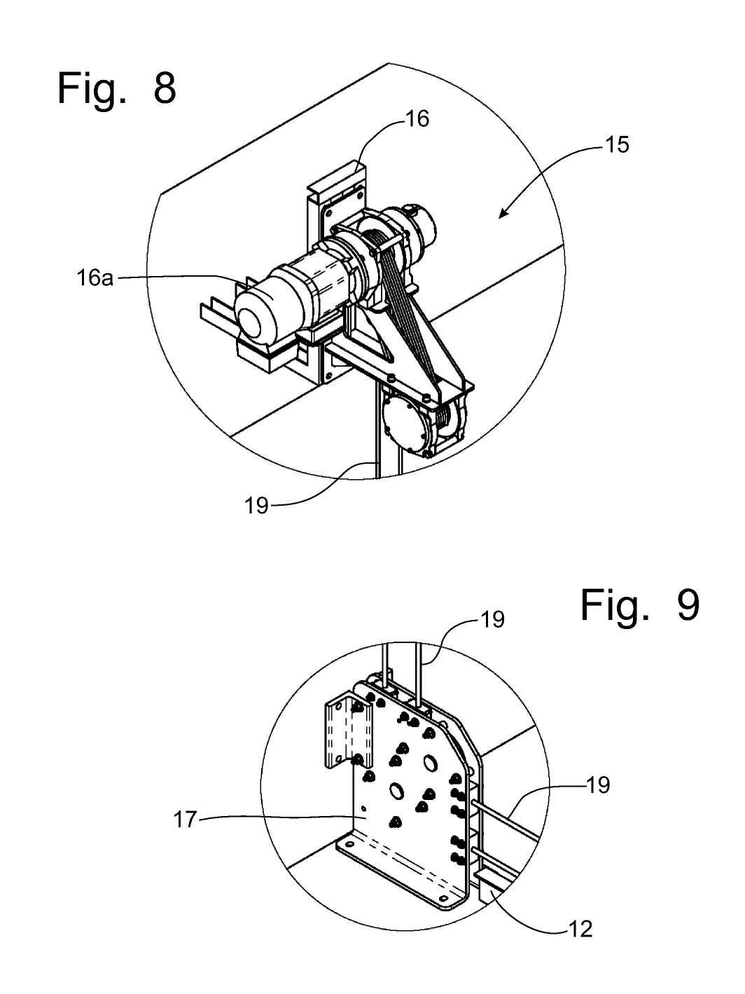

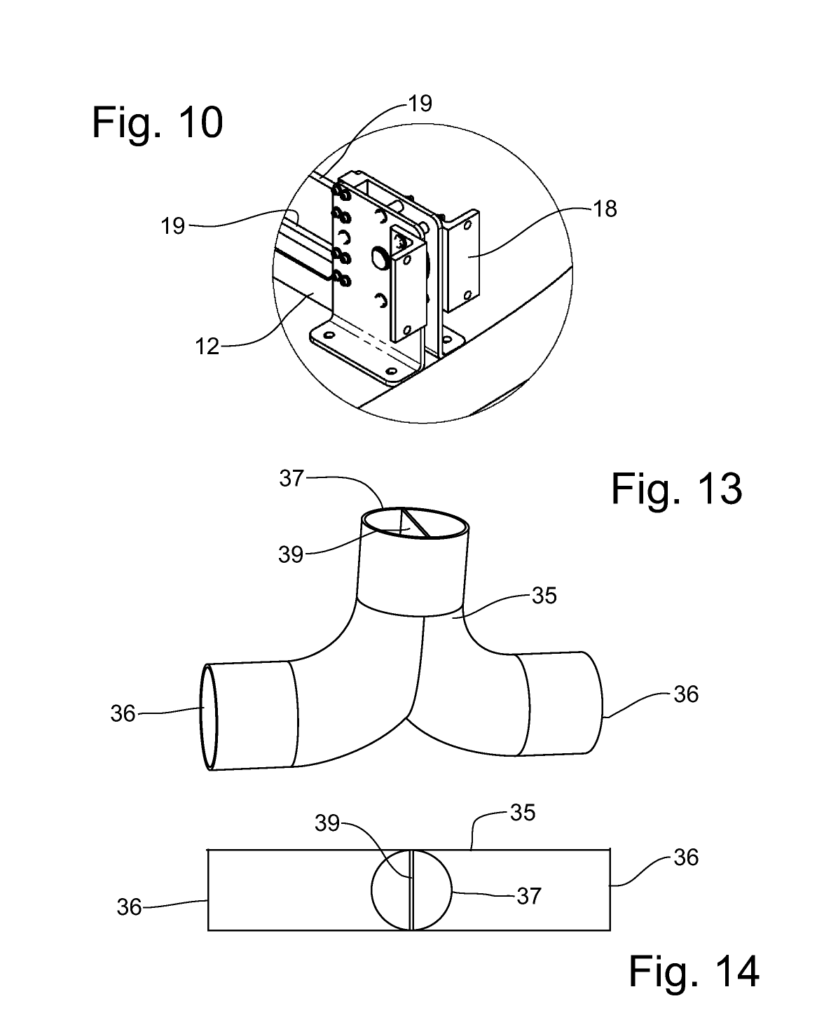

The truck 11 pivotally mounts a pair of header wings 20 at the front end of the truck 11 on the respective transverse sides thereof by respective pivot pins 21a. The header wings 20 are best seen in FIGS. 4-7 and are formed in the shape of a triangle oriented such that the hypotenuse of the triangular shape is the front edge 21 forming the open throat of the header wing 20 and the apex 22 is located at the rear of the header wing 20. The header wing 20 is approximately four inches high with the front edge 21 defining an open inlet throat that does not restrict the movement of sludge from the compressed zone into the header wing 20. To facilitate the movement of the sediment along the side edges 24, the header wings 20 are provided with rollers 26a that support the central and distal portions of the header wings 20 for movement over the floor 9 of the settling tank 5. The inboard end of each header wing 20 is supported by the connection to a pivot pin 26b carried by the chassis 11. With this configuration, each header wing 20 is weight-supported on the rollers 26a and pivot pin 26b to facilitate the collection of the compacted Zone IV sediment.

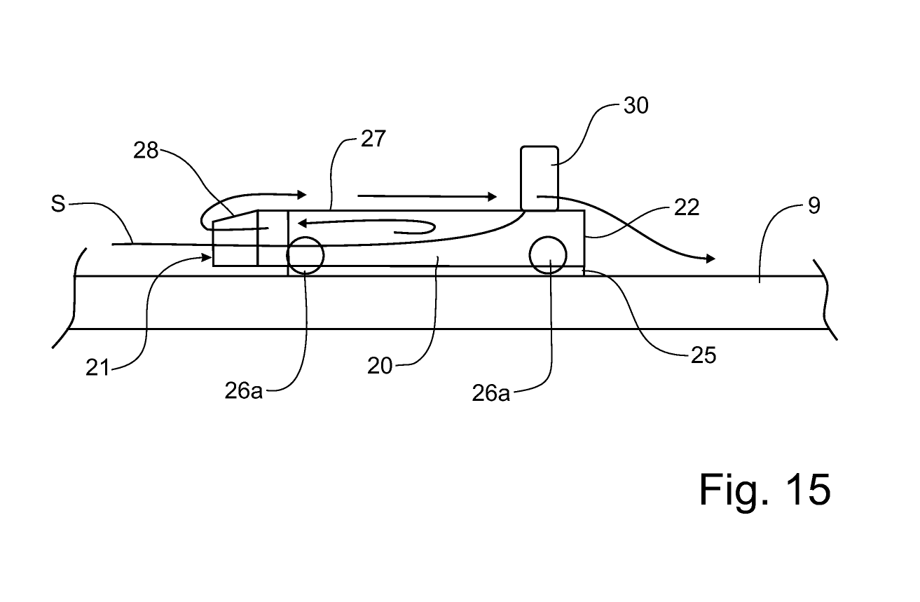

As the header wing 20 moves forwardly along the floor 9 of the settling tank 5, the sludge entering the open throat at the front edge 21 is consolidated toward the apex 22 by the angled sides 24 of the header wing 20. One skilled in the art will understand that the compressed Zone IV sediment along the floor 9 of the settling tank 5 includes up to 3% solids, which allows the sediment to consolidate toward and accumulate into the apex 22 for extraction from the header wings 20 by the pumps 30. The accumulation of the dense sediment from the compacted zone into the apex 22 pushes the less dense layers of sediment forwardly toward the front edge 21 of the header wing 20 as the header wing 20 is moving forwardly, as is depicted schematically in FIG. 15, to force the less dense layers of sediment out of the header wing 20 through the open throat at the front edge 21 to pass over the top of the header wing 20 and be deposited on the floor 9 rearwardly of the forwardly moving sludge collection system 10.

Preferably, the shell 26 of the header wings 20 is formed from stainless steel to provide a structure with an extended operative life requiring a minimum of maintenance. The top surface 27 of the shell 26 is generally planar, but the front portion 28 thereof terminating at the front edge 21 is preferably bent downwardly to facilitate the movement of the upper zones of sediment over the top of the shell 26 to return to the floor 9 of the settling tank 5 behind the header wings 20. Flexible elastomeric sweeps 25, preferably formed of rubber, are attached to the side edges 24 to help scrape the compacted Zone IV sediment off the floor, to prevent the escape of solids underneath the side edges 24, and to help consolidate the collected sediment toward the apex 22. Each flexible elastomeric sweep 25 is attached along the side edges 24 by a retainer 23 that is bolted to the shell 26 through the sweep 25. Thus, the sweeps 25 can be serviced or replaced as needed.

The top surface 27 of each header wing 20 is formed with an access opening 29 near the apex 22 for the extraction of the consolidated sediment accumulating at the apex 22 during the operation of the sludge collection system 10. A pump 30 is fastened to the top surface 27 at the access opening 29 to extract the accumulated and consolidated sludge from the apex 22. Alternatively, the access opening 29 can be utilized to connect a vacuum hose (not shown) that is connected to a remote pump to draw the accumulated sludge through the vacuum hose for removal from the settling tank 5. A brace 22a extends between the apex 22 of each header wing 20 to the truck 11 to stabilize the movement of the header wings 20 with the truck 11 along the guide rail.

The pump 30 is connected to a discharge conduit 32, preferably a flexible hose that is supported along the top surface 27 to the truck 11, although the discharge conduit 32 could be formed of a rigid conduit. Each discharge conduit 32 is connected to a respective inlet port 36 of a T-connector 35 supported on the truck 11. The outlet port 37 of the T-connector 35 is then connected to a flexible discharge conduit 34 that is operable to convey the collected sludge to a location that is remote from the settling tank 5. The T-connector 35 is preferably formed with an internal baffle 39 that separates the two inlet ports 36 through to the discharge port 37 so that if one of the discharge conduits 34 or the corresponding inlet port 36 becomes clogged or partially clogged, the operation of the other discharge conduit and corresponding inlet port will not be affected.

As is best seen in FIGS. 13 and 14, each discharge port 37 of the T-connector 35 has a smaller cross-sectional area than the corresponding inlet port 36. As a result, the movement of sediment and liquid through the discharge port 37 creates a Venturi that expands into the connection of the flexible discharge conduit 34 and thus creates a vacuum with respect to the other discharge port 37. In the event one side of the discharge conduit 32 is plugged and becomes inoperable, the movement of sediment and water through the other discharge port 37 creates a sufficient vacuum on the other discharge port 37 that sediment will not reflux into the clogged side of the sludge collection system 10.

Preferably, the truck or chassis 11 is moved from one end wall 8 to the other end wall 8 by a cable drive mechanism 15. Alternatively, the truck 11 could be equipped with a submersible electric or pneumatic drive mechanism that would power the movement of the sludge collection system 10 along the guide rail 12. The cable drive mechanism 15 includes a drive unit 16, which is preferably an electric motor 16a, mounted above the water in the settling tank 5 to move a cable 19 in the requisite direction for moving the truck 11 connected to the cable 19. One skilled in the art will recognize that the drive motor 16a can be a helical drive, or a planetary drive mechanism, and can be powered pneumatically or hydraulically, as well as electrically.

A home point sheave 17, which can be formed with pulleys or guide blocks (not shown), is mounted to the end wall 8 below the drive unit 16 to change the direction of the cable 19 from the vertical orientation descending from the drive unit 16 to a horizontal orientation to connect to the truck 11. Similarly, a return point sheave 18 is mounted to the opposing end wall 8 to affect a return of the cable 19, as will be described in greater detail below. The return point sheave 18 can be formed with a pulley or a guide block to cause a change in direction of the cable 19.

As is best seen in FIGS. 1, 11 and 12, the cable 19 is connected to the rear connection plate 14a of the truck 11 at the rear end 14 thereof and extends from the truck 11 to the home point sheave 17 to the drive unit 16. The drive unit 16 returns the cable 19 to the home point sheave 17 through a driving engagement with the drive unit 16 to be reoriented toward the truck 11 where the cable 19 passes through the truck 11. The cable 19 then engages the return point sheave 18 and returns direction back to the truck 11 where the cable 19 is connected to the front connection plate 14a of the truck 11. In essence, the cable 19 forms an endless loop that is driven by the drive unit 16 to pull on one end 14a of the truck 11 to move the truck 11 forward in operation and then reverses operative direction to pull on the rearward end 14 of the truck 11 to return the truck 11 back to the home point sheave 17.

As noted above, the front and rear connection plates 14a are pre-tensioned by the springs 14b and movable relative to the corresponding end 14 of the truck chassis 11 to allow some positional flexibility in the configuration of the chassis 11 in case the sludge collection system 10 encounters a significant obstacle at the bottom of the settling tank 5, such as a concrete block or a log, etc. The cable drive mechanism 15 incorporates a shut-down feature that ceases driving the cable 19 when a significant increase in tension in the cable 19 is encountered. The positional flexibility of the chassis 11 allows some movement in the cable drive system 15 without over-tensioning the cable 19 and causing the cable 19 to break. The front and rear ends 14 of the truck 11 are movable along the floor 9 of the settling tank 5 to push the compacted sediment in the Zone IV layer to the opposing sides of the truck 11 where the header wings receive the sediment through the open throat 21 therein.

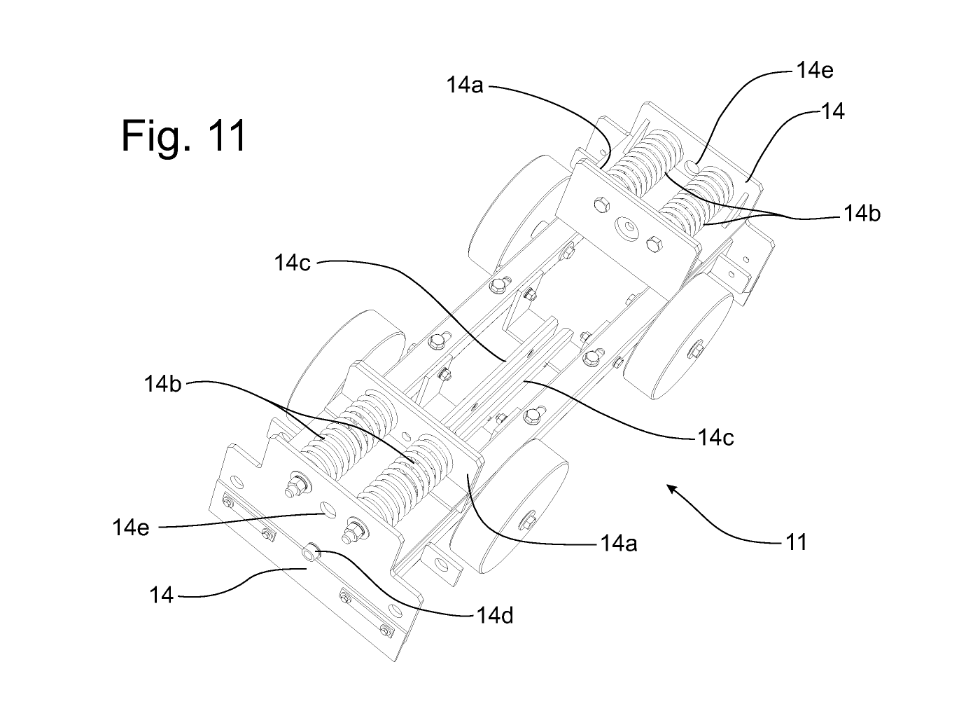

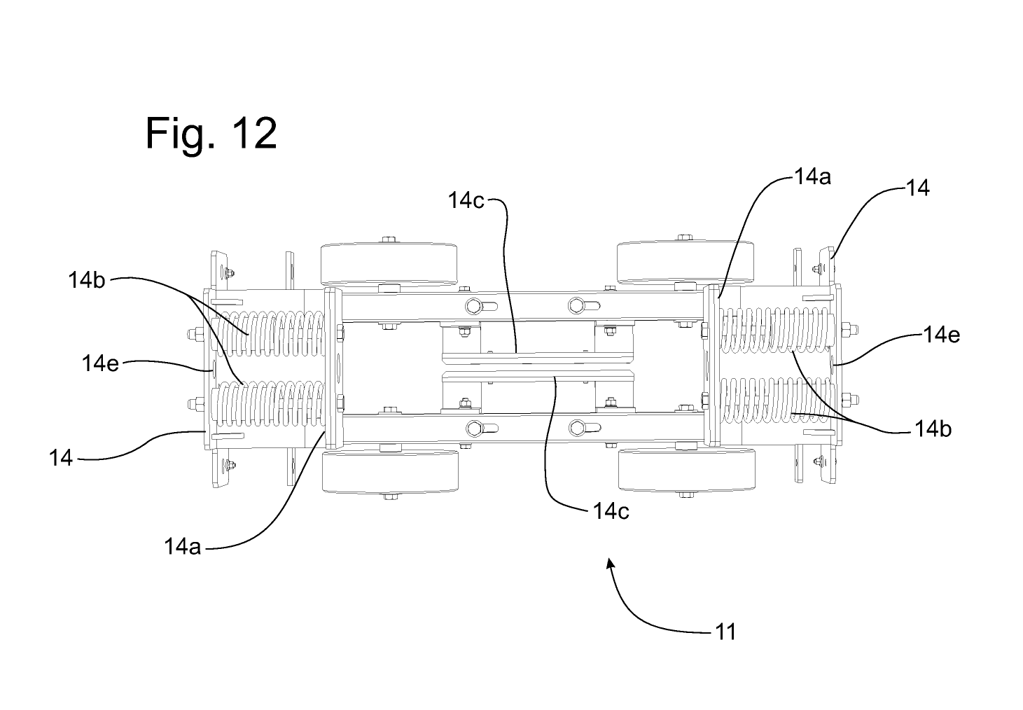

As best seen in FIGS. 11 and 12, the truck chassis 11 includes a pair of laterally spaced slide rails 14c that engage the guide rail 12 to keep the truck 11 moving along the guide rail 12 as the cable drive mechanism 15 powers the movement of the truck 11. The front and rear ends 14 include a grommet 14d to allow the passage of the cable 19 through the truck 11, as is described in greater detail above, so that the cable can extend between the home point sheave 17 and the return sheave 18 and enable the cable to be connected to both of the connection plates 14a, passing through aligned holes 14e in the front and rear ends 14, respectively, to reach the corresponding connection plate 14a.

In operation, the sludge collection system 10 is preferably manually operated by activating the drive unit 16 to cause the truck 11 and attached header wings 20 to move forwardly into the compressed zone of sediment accumulated at the bottom floor 9 of the settling tank 5. The pumps 30 also need to be activated at the same time as the drive unit 16. Preferably, a control panel 40 is provided at the settling tank 5 to control the electrical operation of the drive unit 16 and pumps 30. Alternatively, the sludge collection system 10 could be automated through a microprocessor (not shown) in the control box 40 to operate the sludge collection system 10 on a timed basis. Limit switches (not shown) can be utilized to inform the control box 40 that an end wall 8 has been reached on either the operative run or on the return run.

Once the drive unit 16 is activated, the sludge collection system 10 will move forwardly from the home point sheave 17 toward the return point sheave 18 pulling the sludge from the compressed zone through the open throat of each header wing 20 to be consolidated by the sweeps 25 mounted to the side edges 24 toward the apex 22 where the pump 30 extracts the consolidated and accumulated sludge from the shell 26 of the header wing 20 to pass the sludge through the discharge conduits 32, 34 to a location remotely from the settling tank 5, where the discharged sludge can be treated independently. As reflected in FIG. 15, the accumulated sludge S fills the apex 22 of each header wing 20 to force the less dense sediment zones forwardly through the open throat at the front edge 21, as represented by the arrows in FIG. 15, to pass over the bent front portion 28 and over the planar top surface 27 to be deposited on the floor 9 rearwardly of the header wings 20.

The truck 11 continues moving forwardly gathering the sludge from the compressed zone until the truck 11 reaches the return point sheave 18 at the opposing end wall 8. At this point, a limit switch (not shown) is engaged and the drive unit 16 reverses direction to pull on the rearward end 14 of the truck 11 on a return run to reposition the sludge collection system 10 at the home position adjacent the home point sheave 17. The front end 14 of the truck pushing the sediment along the floor 9 of the settling tank 5 to either side thereof into the adjacent header wings 20 for accumulation therein.

With the extraction of the sediment from the compressed zone, the sediment in the zones above the header wings 20 move over the top of the front portion 28 and the planar top surface 27 of the shell 26 to be deposited along the floor 9 of the settling tank 5 behind the header wings 20. Upon the return of the sludge collection system 10 to the home position next to the home point sheave 17, the remaining sludge from the upper sediment zones is redistributed along the floor 9 of the settling tank 5. Ultimately, with the continued operation of the settling tank 5 and the accumulation of additional sediment, the lowermost layer becomes the compressed zone, which is then subsequently collected and removed from the settling tank 5 with the operation of the sludge collection system 10.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A method of collecting sediment from a sedimentation basin having longitudinally spaced end walls to remove accumulated sediment from said sedimentation basin, comprising the steps of:
providing a sludge collection system movable along the bottom surface of said sedimentation basin, said sludge collection system including a central truck movable along a guide rail within said sedimentation basin and a pair of triangularly shaped header wings;
engaging a compressed Zone IV sediment layer by said header wings;
consolidating the Zone IV sediment into the trailing apex of the header wing;
accumulating said Zone IV sediment at the apex of each respective said header wing; and
extracting said Zone IV sediment from said apex for removal from said sedimentation tank.

2. The method of claim 1 wherein said engaging step includes the steps of:
positioning said sludge collection system on a floor of said sedimentation basin; and
driving said sludge collection system forwardly along said guide rail.

3. The method of claim 2 wherein said consolidating step includes the steps of:
mounting a sweep on each diagonally oriented, rearwardly extending side of each said header wing; and
pulling said sweeps along said floor.

4. The method of claim 3 wherein said accumulating step includes the steps of:
retaining said Zone IV sediment beneath the respective said header wings as said header wings move forwardly during said driving step; and
passing sediment layers less dense than said Zone IV sediment layer rearwardly over said header wings to be deposited on said floor rearwardly of said header wings.

5. The method of claim 4 wherein said passing step includes the steps of:
Forcing said less dense sediment layers forwardly beneath the header wing to the front edge.

6. The method of claim 4 wherein said extracting step includes the step of:
pumping the accumulated sediment through an opening in a top surface of said header wing and discharging said accumulated sediment from said sedimentation basin.

7. A method of removing sediment from a settling tank comprising the steps of:
providing a sludge collection system movable along the bottom surface of said settling tank, said sludge collection system including a central truck movable along a guide rail within said settling tank and a pair of triangularly shaped header wings extending laterally from said central truck, each said header wing being oriented with an apex positioned rearwardly of a front edge;
driving said sludge collection system forwardly along said guide rail;
passing a compressed Zone IV sediment layer through an open throat along said front edge into said header wing;
consolidating the Zone IV sediment into the rearwardly positioned apex of the header wing;
accumulating said Zone IV sediment in the apex of each respective said header wing; and
extracting said Zone IV sediment from said apex for removal from said sedimentation tank.

8. The method of claim 7 wherein said consolidating step is accomplished by an elastomeric sweep attached to diagonally extending rearward edges of each said header wing, said rearward edges meeting at said apex.

9. The method of claim 8 wherein said elastomeric sweeps engage the floor of said settling tank to restrict the passage of sediment from the corresponding said header wing.

10. The method of claim 9 wherein said accumulating step pushes sediment layers less dense that said Zone IV sediment layer forwardly beneath said header wings as said header wings are driven forwardly along said guide rail.

11. The method of claim 10 wherein said less dense sediment layers pass over a top surface of said header wings to be deposited on the floor of said settling tank rearwardly of said header wings.

12. The method of claim 11 wherein said driving step is accomplished with a cable drive system connected to said central truck to move said sludge collection system along said guide rail.

13. The method of claim 12 wherein said extracting step is accomplished by a pump mounted on the top surface of each said header wing to withdraw said accumulated sediment through a hole in said top surface located at said apex.

14. The method of claim 13 wherein said extracting step includes a T-connector interconnecting the laterally spaced pumps with a discharge hose, said extracting step including the step of:
establishing separate flow paths through said T-connector from each respective said pump to said discharge hose by locating a baffle in said T-connector that prevents the flow from the respective pumps from combining until reaching the discharge hose.

15. The method of claim 14 wherein said extracting step further includes the step of:
creating a Venturi zone at the connection of said discharge hose to said T-connector by having said baffle form two sub-ports at an outlet port of said T-connector, each said sub-port having a smaller cross-sectional area than the corresponding said inlet port receiving sediment flow from the corresponding pump.

16. In a sludge collection system for removing sediment from a settling tank, said sludge collection system including a transverse sediment removal apparatus coupled to a pair of laterally spaced conduits for removing collected sediment from said sediment removal apparatus into a common discharge hose for discharge of the collected sediment from said settling tank, the improvement comprising:
a T-connector having a pair of inlet ports and an outlet port, said inlet ports being connected to said conduits and said outlet port being connected to said discharge hose, said T-connector including a baffle defining separate flow paths from each respective inlet port to said outlet port.

17. The sludge collection system of claim 14 wherein said outlet port is divided into two sub-ports, each said sub-port having a smaller cross-sectional area than the corresponding said inlet port.

18. The sludge collection system of claim 14 wherein said baffle extends to the end of said outlet port so that the discharge of sediment from each said sub-port is directly into said discharge hose.
